(19) United States
(12) Patent Application Publication
(10) Pub. No.: US 2025/0369077 A1
(43) Pub. Date: Dec. 4, 2025

(54) Cobalt-Nickel Nanoparticles for Oxygen Reduction Reactions

(71) Applicants: Ibrahim A. Shaaban, Islamabad (PK); Mohammed Assiri, Abha (SA); Muhammad Sofian, Islamabad (PK); Muhammad Nadeem, Abha (SA); Muhammad Imran, Abha (SA)

(72) Inventors: Ibrahim A. Shaaban, Islamabad (PK); Mohammed Assiri, Abha (SA); Muhammad Sofian, Islamabad (PK); Muhammad Nadeem, Abha (SA); Muhammad Imran, Abha (SA)

(21) Appl. No.: 18/732,434

(22) Filed: Jun. 3, 2024

(51) Int. Cl. C22C 19/03; B22F 1/054; B22F 9/24; B22F 9/30

(52) U.S. Cl. CPC C22C 19/03; B22F 1/054; B22F 9/24; B22F 9/305

(57) ABSTRACT

The present disclosure provides a method for synthesizing cobalt-nickel alloy nanoparticles. The method involves dissolving potassium hydroxide in a mixture of ethylene glycol and N, N-dimethylformamide. Cobalt II acetylacetonate and nickel II acetylacetonate are added to the solution. The cobalt II acetylacetonate and nickel II acetylacetonate are stirred into the solution until the cobalt II acetylacetonate and nickel II acetylacetonate have dissolved. The solution is transferred to an autoclave, which in some embodiments is lined with PTFE. The autoclave is heated until the nanoparticles have been synthesized. In some embodiments, the autoclave is heated at 180° C. for 8 hours. The synthesized nanoparticles are collected by centrifuging the product having the synthesized nanoparticles. The nanoparticles are characterized and evaluated for oxygen reduction reaction.

### COPYRIGHT STATEMENT

A portion of the disclosure of this specification document contains material that is subject to copyright protection. The copyright owner has no objection to the facsimile reproduction by anyone of the specification document or the specification disclosure as it appears in the Patent and Trademark Office patent file or records, but otherwise reserves all copyright rights whatsoever.

Trademarks used in the disclosure of the invention, and the applicants make no claim to any trademarks referenced.

### BACKGROUND OF THE INVENTION

### 1) Field of the Invention

The invention relates in general to the field of catalysts for oxygen reduction reactions (ORRs), and more particularly, to cobalt-nickel alloy nanoparticles for ORRs.

### 2) Description of Related Art

Oxygen reduction is integral to the functioning of some fuel cells, which convert chemical potential energy into electrical energy. Fuel cells are considered a promising alternative to traditional fossil fuels due to their high energy efficiency and low environmental impact.

The efficiency of these reactions is at least partly dependent on the catalysts used. Traditionally, platinum-based catalysts have been employed due to their high catalytic activity. However, the scarcity and high cost of platinum have driven the search for alternative catalysts. Accordingly, this specification recognizes a need for an alternative catalyst.

These and other objects, features, and advantages of the present invention will become more readily apparent from the attached drawings and the detailed description of the preferred embodiments, which follow.

### SUMMARY OF THE INVENTION

The current innovation is in sustainable energy technology concerning electrocatalytic oxygen reduction involves processes for the synthesis of cobalt and nickel alloy nanoparticles through a solvothermal reaction approach. The solvothermal method is advantageous due to its simplicity, cost-effectiveness, and ability to produce nanoparticles with controlled sizes and compositions. The properties of the nanoparticles can be tuned by adjusting the composition of the alloy, allowing for the optimization of the catalytic activity of the nanowire. Cobalt and nickel alloy nanoparticles are suitable for meeting the rising needs of fuel cell technology for expanding populations. Nanomaterials have a high surface area-to-volume ratio and have tunable properties. One-dimensional nanostructures such as nanoparticles and nanotubes offer additional advantages due to their directional properties, distinctive structure, and surface characteristics.

### Synthesis of Cobalt-Nickel Alloy Nanoparticles

The above and other objects, which will be apparent to those skilled in the art, are achieved in the present invention which is directed to nanoparticles for use as a catalyst in oxygen reduction reactions. The nanoparticles are made by a method comprising the following steps. Ethylene glycol is mixed with N, N-dimethylformamide, forming a mixture. Potassium hydroxide is dissolved in the mixture of ethylene glycol and N, N-dimethylformamide forming a resultant solution. A metal precursor salt, having at least cobalt or nickel, is dissolved in the resultant solution to form a solution that has the metal precursor salt dissolved therein. The solution having the metal precursor salt dissolved therein is transferred to an autoclave. The autoclave is heated to form a product having nanoparticles. The nanoparticles are collected by centrifuging the product having the nanoparticles.

Still other objects and advantages of the invention will in part be obvious and will in part be apparent from the specification. In various embodiments, the metal salt precursor includes a nickel salt precursor. In various embodiments, the metal salt precursor includes a cobalt salt precursor. In various embodiments, the metal salt precursor includes a cobalt salt precursor and a nickel salt precursor, and the nanowire is a cobalt-nickel alloy nanowire. In various embodiments, the cobalt-nickel alloy is CoₙNi₁₀₀₋ₙ, where n is greater than 0 and less than 100. In various embodiments, the dissolving of the metal salt precursor is performed by stirring the metal salt into the resultant solution. In various embodiments, the stirring is performed gently enough to avoid creating turbulence in the solution. In various embodiments, the stirring is performed gently enough to avoid creating bubbles in the solution. In various embodiments, the nickel salt precursor is nickel II acetylacetonate.

In various embodiments, the cobalt salt precursor is cobalt II acetylacetonate. In various embodiments, the method further comprises determining a desired composition for the cobalt-nickel alloy nanoparticles and adjusting a molar ratio of cobalt II acetylacetonate and nickel II acetylacetonate, based on the desired composition of the cobalt-nickel alloy nanoparticles. In various embodiments, the cobalt-nickel alloy nanoparticles retain an initial catalytic activity for over 8000 cycles of oxygen reduction reactions. In various embodiments, the method further comprises performing an oxygen reduction reaction in a fuel cell in which the cobalt-nickel alloy nanoparticles are a catalyst. In various embodiments, the cobalt-nickel alloy nanoparticles have a diameter ranging from 10 to 100 nanometers.

In various embodiments, the cobalt-nickel alloy nanoparticles have a length ranging from 1 to 10 microns. In various embodiments, the cobalt-nickel alloy nanoparticles exhibit a catalytic activity towards oxygen reduction reaction that has a reaction rate that is within 50% of a platinum-based catalyst. In various embodiments, the cobalt-nickel alloy nanoparticles exhibit a catalytic activity towards oxygen reduction reaction that has a reaction rate that is within 75% of a platinum-based catalyst. In various embodiments, the method for the synthesis of CoₙNi₁₀₀₋ₙ nanoparticles comprises transferring the solution to the autoclave and heating the autoclave at 180° C. for a period of time sufficient to form CoₙNi₁₀₀₋ₙ. In various embodiments, the method for the synthesis of CoₙNi₁₀₀₋ₙ nanoparticles comprises transferring 80 ml of the solution to a PTFE-lined autoclave and heating the autoclave for 8 h at 180° C. In various embodiments, the method for the synthesis of CoₙNi₁₀₀₋ₙ nanoparticles comprises filtering and drying the product having the nanoparticles, at 70° C. in an oven.

In various embodiments, the method comprises dispersing the CoₙNi₁₀₀₋ₙ alloy nanoparticles, by adding the CoₙNi₁₀₀₋ₙ alloy nanowire to a mixture of isopropanol and 5% sulfonated tetrafluoroethylene based fluoropolymer-copolymer mixture, 100 μL, in a sonicator with a 100 W power output and about 42 kHz of frequency. In various embodiments, the method further comprises catalytically activating the nanoparticles in an oxidation reduction reaction and extracting energy from the oxidation reduction reaction. In various embodiments, a method for evaluating electrocatalytic activity of the cobalt-nickel alloy nanoparticles synthesized by dispersing the cobalt-nickel alloy nanoparticles in a mixture of isopropanol and sulfonated tetrafluoroethylene based fluoropolymer-copolymer, forming a resultant slurry, applying the resultant slurry to a rotating disk electrode; and measuring oxygen reduction activity by a potentiostat. In various embodiments, the mixture of isopropanol and sulfonated tetrafluoroethylene-based fluoropolymer-copolymer is prepared in a ratio of 9:1. In various embodiments, the resultant slurry is sonicated for a duration of 2 hours before application to the rotating disk electrode. In various embodiments, a method comprising evaluating electrocatalytic activity of the cobalt-nickel alloy nanoparticles synthesized by dispersing the cobalt-nickel alloy nanoparticles in a mixture of isopropanol and sulfonated tetrafluoroethylene-based fluoropolymer-copolymer, forming a resultant slurry, placing the resultant slurry on a rotating disk electrode, and measuring oxygen reduction activity by a potentiostat. In various embodiments, the rotating disk electrode is coated with a slurry having the cobalt-nickel alloy nanoparticles, by drop-casting the slurry onto the rotating disk electrode. In various embodiments, oxygen reduction activity is measured in an electrolyte solution saturated with oxygen.

In various embodiments, the electrolyte solution is 0.1 M KOH. In various embodiments, CoₙNi₁₀₋ₙ alloy nanoparticles are formed by a method comprising, mixing N, N-dimethylformamide and ethylene glycol to form a mixture of ethylene glycol and N, N-dimethylformamide, dissolving potassium hydroxide in the mixture of ethylene glycol and N, N-dimethylformamide, forming a resultant solution, dissolving a cobalt salt precursor and a nickel salt precursor in the resultant solution to form a solution that has the cobalt salt precursor and the nickel salt precursor salt dissolved therein, the cobalt salt precursor being cobalt II acetylacetonate and the nickel salt precursor being nickel II acetylacetonate, transferring, to an autoclave, the solution that has the cobalt salt precursor and the nickel salt precursor salt dissolved therein, heating the solution that has the cobalt salt precursor and the nickel salt precursor salt dissolved therein, to form a product having the CoₙNi₁₀₋ₙ alloy nanoparticles, and collecting the CoₙNi₁₀₋ₙ alloy nanoparticles by centrifuging the product having the CoₙNi₁₀₋ₙ alloy nanoparticles. Optionally, the CoₙNi₁₀₀₋ₙ nanoparticles or batches of the CoₙNi₁₀₀₋ₙ nanoparticles are evaluated and sorted based on the evaluation.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a flowchart of an example of a method of making nanoparticles.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few examples of embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

### Definitions

Autoclave: In the context of this specification, an autoclave refers to a device used to conduct industrial and scientific processes requiring elevated temperature and/or pressure different from ambient air pressure. In this specification, in some embodiments, the autoclave is used for the solvothermal synthesis of cobalt-nickel alloy nanoparticles. The autoclave allows for the control of temperature and pressure conditions, which are integral to the formation of the nanoparticles. In various embodiments, the autoclave used in this method is lined with polytetrafluoroethylene, a chemically inert material, to prevent any unwanted reactions between the solution and the autoclave material.

Catalytic Activity: In the context of this specification, catalytic activity refers to the ability of a substance, in this case, the cobalt-nickel alloy nanoparticles, to speed up a chemical reaction without being consumed during the reaction. The catalytic activity is often quantified by the rate at which the reaction occurs.

Catalytic Activity towards ORR refers to the ability of the cobalt-nickel alloy nanoparticles to accelerate the ORR. Nanoparticles having a catalytic activity towards ORR refers to the effectiveness of the nanoparticles in catalyzing the reaction, which is integral to the functioning of fuel cells. The catalytic activity towards ORR can be evaluated by measuring the rate of the reaction in the presence of the nanoparticles and comparing it to the rate of the reaction without the nanoparticles.

Nanoparticles: are wires having a diameter that is between 0.1 and 100 nanometers.

Cobalt-nickel nanoparticles, such as CoₙNi₁₀₀₋ₙ nanoparticles, are nanoparticles composed of cobalt and nickel, which may be one-dimensional. In some embodiments, the composition of the nanoparticles can be adjusted by changing the molar ratio of the metal precursors used in the synthesis process. In some embodiments, the nanoparticles are specifically designed for catalyzing the ORR within fuel cells.

Electrocatalytic Activity is the ability of a material to facilitate an electrochemical reaction by lowering the energy barrier for the reaction. In this specification, in some embodiments, the electrocatalytic activity of the CoₙNi₁₀₀₋ₙ nanoparticles is evaluated in terms of their ability to facilitate the ORR.

Electrochemical Impedance Spectroscopy (EIS) is an electrochemical technique used to measure the impedance of a system over a range of frequencies. In this specification, in some embodiments, EIS is used to indicate the charge transfer resistance during formic acid oxidation on the surface of an electrode.

Enhanced Durability: In the context of this specification, enhanced durability refers to the ability of a catalyst to maintain its catalytic activity and optionally maintain structural integrity during ORRs. For example, the nanoparticles exhibit a high resistance to degradation and wear, during fuel cell operation, despite high temperatures, corrosive environments, and high current densities. Enhanced durability may be quantified by the number of cycles of reaction the nanoparticles can perform without a substantial loss in their catalytic activity or a noticeable change in their physical properties. In some embodiments, each cycle is one revolution of a rotating disk electrode of a three-electrode system. In this specific case, the cobalt-nickel alloy nanoparticles are described as having enhanced durability over 8000 cycles of ORRs.

Gentle Stirring: In the context of this specification, in some embodiments, gentle stirring refers to the process of stirring slowly enough to not cause turbulence. In some embodiments, gentle stirring refers to the process of stirring slowly enough to not create bubbles. In some embodiments, gentle stirring ensures that the components of a solution are mixed into a uniform distribution and complete dissolution of the solutes. The formation of air bubbles or the creation of turbulence can potentially interfere with the subsequent synthesis steps. In some embodiments, gentle stirring may be achieved using a magnetic stirrer or other suitable stirring device.

Linear Sweep Voltammetry is an electrochemical technique where the potential of the working electrode is scanned over time, and the resulting current is measured. In some embodiments, the scanning occurs linearly over time. In this specification, in some embodiments, linear sweep voltammetry is used to measure the electrocatalytic performance of the CoₙNi₁₀₀₋ₙ nanoparticles.

A Metal Precursor is a compound or substance that undergoes a chemical reaction to form a different, often more complex, substance. In the context of this specification, in some embodiments, the metal precursors are metal salts, such as cobalt II acetylacetonate and nickel II acetylacetonate, which are used in the synthesis of the CoₙNi₁₀₀₋ₙ nanoparticles.

The Metal Precursor Molar Ratio is the ratio of the moles of one metal precursor to another in a reaction. In this specification, in some embodiments, the metal precursor molar ratio refers to the ratio of cobalt salt to nickel salt used in the synthesis of the CoₙNi₁₀₀₋ₙ nanoparticles.

Oxygen Reduction Reaction (ORR) refers to a chemical reaction where oxygen, O₂, is reduced. In some embodiments, ORR results in the production of water, H₂O, or hydroxide ions, OH—. In the context of this specification, the ORR is a process used in the operation of fuel cells, where, in some embodiments, the process facilitates the conversion of oxygen into water, releasing energy in the process.

A potentiostat is an electronic instrument that controls the voltage difference between a working electrode and a reference electrode. In some embodiments, both electrodes are contained in an electrochemical cell. The potentiostat operates by adjusting the current at a counter electrode within the cell, maintaining the desired potential difference. In the context of this specification, in some embodiments, the potentiostat is used to measure the electrocatalytic activity of the synthesized cobalt-nickel alloy nanoparticles towards an ORR.

PTFE refers to polytetrafluoroethylene. In some embodiments, the PTFE is a plastic having non-stick properties, high-temperature resistance, and/or chemical resistance. In this specification, in some embodiments, PTFE lines or coats the walls of an autoclave or a container in the autoclave in which a slurry or solution that has Co and Ni is placed to synthesize CoₙNi₁₀₀₋ₙ nanoparticles.

A Rotating Disk Electrode (RDE) is a type of electrode used in electrochemical analysis, where the electrode is rotated, such as in the three-electrode system. In some embodiments, the rotation controls the diffusion layer of a mixture placed on the RDE. In this specification, in some embodiments, an RDE is used as the working electrode in the evaluation of the electrocatalytic activity of the CoₙNi₁₀₀₋ₙ nanoparticles.

A Solvothermal Method is often used in materials synthesis, where the reaction occurs in a solvent at temperatures above the solvent's boiling point and optionally at pressures higher than atmospheric pressure. In the context of this specification, in some embodiments, the solvothermal method is used to synthesize cobalt-nickel alloy nanoparticles.

Sonication: In the context of this specification, sonication refers to agitating particles in a solution by subjecting the particle to sound waves. In some embodiments, the sonication facilitates dispersing particles that are in a solution, which may ensure a uniform distribution for subsequent electrochemical measurements. A sonicator causes sonication, which generates sound waves at a specific frequency to agitate the particles in the solution.

Three Electrode Systems: In the context of this specification, a three-electrode system refers to an electrochemical cell setup that includes a working electrode, a reference electrode, and a counter electrode. The working electrode is where the electrochemical reaction of interest occurs. In some embodiments, the electrochemical reaction of interest is an ORR. The reference electrode provides a stable and known potential against which the potential at the working electrode can be measured. The counter electrode completes the circuit and allows current to flow through the system.

The terms Teflon™ and PTFE are used interchangeably to mean PTFE. The terms Nafion™ and sulfonated tetrafluoroethylene-based fluoropolymer as used in the specification are meant to mean sulfonated tetrafluoroethylene-based fluoropolymer copolymer.

Before a discussion of the preferred embodiment of the invention, it should be understood that while the features and advantages of the invention are illustrated in terms of Cobalt-Nickel Nanoparticles for ORR, the invention is not limited to these features. In an alternative embodiment, Cobalt-Nickel powders are produced instead of nanoparticles and used for ORR. The methods of this specification involve dissolving potassium hydroxide in a mixture of ethylene glycol and N, N-dimethylformamide, followed by adding a cobalt salt and nickel salt, such as cobalt II acetylacetonate and nickel II acetylacetonate. The resultant solution is then transferred to a PTFE-lined autoclave and heated at a specific temperature for a set duration. The synthesized cobalt-nickel alloy nanoparticles are collected by centrifugation. The centrifuged nanoparticles are then washed and dried for further use. The composition of the nanoparticles can be controlled by adjusting the molar ratio of the cobalt II acetylacetonate and nickel II acetylacetonate.

In addition, the disclosure provides a method for evaluating the electrocatalytic activity of the synthesized cobalt-nickel alloy nanoparticles. The evaluation involves dispersing the nanoparticles in a mixture of isopropanol and sulfonated tetrafluoroethylene-based fluoropolymer-copolymer, applying the resultant slurry or solution on a RDE, and measuring the ORR using a potentiostat. The synthesized nanoparticles may exhibit a catalytic activity towards ORR that is comparable to that of platinum-based catalysts and exhibit enhanced durability over multiple cycles of ORRs.

The methods and nanoparticles disclosed herein provide a cost-effective and efficient alternative to traditional platinum-based catalysts in fuel cells. The tunable composition of the nanoparticles allows for customization based on specific application requirements, and the method of synthesis is easily scalable for different-sized industrial productions. Furthermore, the method for evaluating the electrocatalytic activity of the nanoparticles provides a reliable and accurate measure of the performance of the nanoparticles in ORRs.

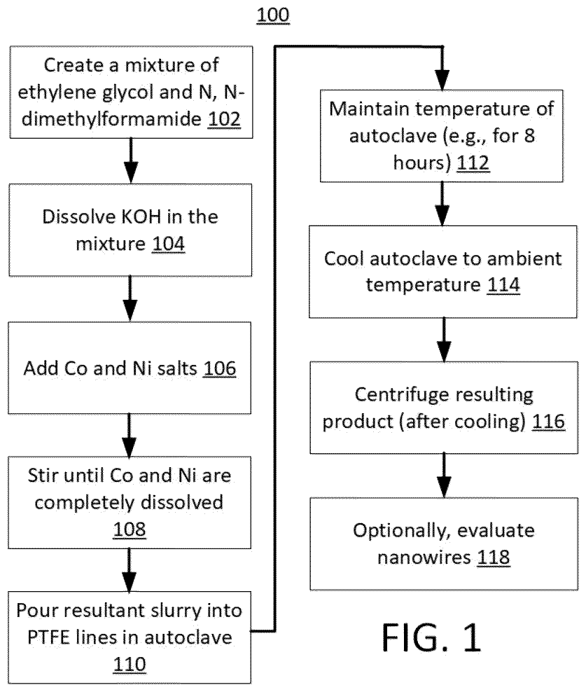

Referring to FIG. 1, in some embodiments, in method 100, in step 102, ethylene glycol and N, N-dimethylformamide are mixed together. The choice of ethylene glycol and N, N-dimethylformamide as solvents provides a suitable environment for the synthesis of the nanoparticles, because ethylene glycol and N, N-dimethylformamide have appropriate polarity and viscosity characteristics for growing the nanoparticles.

In step 104, KOH is dissolved into the mixture. In some embodiments, the mixture of ethylene glycol and N, N-dimethylformamide is degassed to not react with the KOH, for example. In some cases, the dissolution of potassium hydroxide in the solvent mixture may be achieved by gently stirring the mixture, avoiding turbulence, or avoiding bubbles, until the potassium hydroxide is dissolved, because the turbulence or bubbles may cause gases, such as air, to dissolve in the mixture, which may react with the potassium, for example. The stirring may be performed at room temperature, although other temperatures may also be suitable. The stirring may be performed using a magnetic stirrer, although other methods may also be used. The duration of the stirring may vary depending on the amount of potassium hydroxide and the temperature. The container holding the solution may be sealed during the dissolution of the potassium hydroxide to prevent evaporation of the solvents. After the dissolution of the potassium hydroxide, the solvent mixture may be ready for the addition of the metal precursors.

Then, following the dissolution of potassium hydroxide in the solvent mixture, in step 106, metal salts, such as cobalt salts and nickel salts, are added to the resultant solution. In some embodiments, the cobalt salt includes cobalt II acetylacetonate and the nickel salt includes nickel II acetylacetonate. The cobalt salt and nickel salt serve as metal salt precursors for the synthesis of cobalt-nickel alloy nanoparticles. The addition of these precursors to the solution having the KOH may be performed at room temperature, although other temperatures may also be suitable. The precursors may be added in solid form and may be stirred into the solution until complete dissolution.

In some embodiments, the molar ratio of cobalt II acetylacetonate to nickel II acetylacetonate may be adjustable. The adjustability may allow for control over the composition of the synthesized cobalt-nickel alloy nanoparticles. For instance, a higher molar ratio of cobalt II acetylacetonate to nickel II acetylacetonate may result in nanoparticles with a higher cobalt content, while a lower molar ratio may result in nanoparticles with a higher nickel content. The tunability of the composition may enable the customization of the nanoparticles based on specific application requirements.

The KOH dissolved into the mixture serves as a solvent system for the subsequent addition of metal precursors. The potassium hydroxide acts as a base, facilitating the dissolution of the metal precursors and promoting the formation of the nanoparticles. In some embodiments, the concentration of potassium hydroxide in the solvent mixture may be adjusted to control the pH of the solution, which may in turn influence the morphology and composition of the synthesized nanoparticles. For example, a higher concentration of potassium hydroxide may result in a higher pH, which may promote the formation of nanoparticles with a larger diameter or a higher nickel content. Conversely, a lower concentration of potassium hydroxide may result in a lower pH, which may promote the formation of nanoparticles with a smaller diameter or a higher cobalt content. The solvent mixture may be prepared in a glass container, although other types of containers may also be suitable. The container may be sealed during the dissolution of the potassium hydroxide to prevent evaporation of the solvents.

In step 108, the solution having the metal salt precursor is stirred. The stirring of the solution containing the metal precursors may be performed magnetically until the complete dissolution of the cobalt II acetylacetonate and nickel II acetylacetonate. The duration of the stirring may vary depending on the amount of the precursors and the temperature, but in some cases, the stirring may continue until the precursors are completely dissolved. The complete dissolution of the metal salts may ensure a uniform distribution of the metal ions in the solution, which may in turn result in a uniform composition of the cobalt-nickel alloy nanoparticles.

The duration of the magnetic stirring may vary depending on various factors, such as the concentration of the metal precursors, the temperature of the solution, and the stirring speed. However, in some embodiments, the magnetic stirring may continue until the cobalt II acetylacetonate and nickel II acetylacetonate are completely dissolved in the solution. Complete dissolution of the metal salts may ensure a uniform distribution of the metal ions in the solution, which may be beneficial for the subsequent synthesis of the cobalt-nickel alloy nanoparticles. The magnetic stirring may be performed at room temperature, although other temperatures may also be suitable. The stirring speed may be adjusted based on the specific requirements of the dissolution process. For instance, a higher stirring speed may facilitate a faster dissolution of the metal precursors, while a lower stirring speed may be suitable for a more controlled dissolution process. However, the stirring is performed gently enough to avoid turbulence or to avoid creating bubbles. The container may be sealed during the stirring process to prevent evaporation of the solvents and loss of the metal precursors. After the complete dissolution of the cobalt II acetylacetonate and nickel II acetylacetonate, the solution may be ready for the subsequent steps of the synthesis process, as described in the following steps.

In step 110, the solution containing the dissolved metal precursors may be transferred to an autoclave for the subsequent synthesis of the nanoparticles. The transfer may be performed using a pipette, a syringe, or any other suitable transfer device. In some embodiments, the transfer of the solution to the autoclave may be performed at room temperature, although other temperatures may also be suitable. The transfer may be performed quickly to minimize the exposure of the solution to the ambient environment, which may help maintain the integrity of the solution and the dissolved metal precursors.

The autoclave is lined with PTFE. The autoclave may provide a sealed environment for solvothermal synthesis. The PTFE lining may be chemically inert and may prevent any unwanted reactions between the solution and the autoclave material. The chemically inert environment of the autoclave may prevent any unwanted reactions between the solution and the autoclave material. Alternatively, the autoclave is lined with another material that is chemically inert even at high temperatures. For example, the autoclave may be lined with a ceramic that is inert at high temperatures. The volume of the autoclave may be chosen based on the volume of the solution. In some cases, an autoclave with a volume of 80 mL may be used, although other volumes may also be suitable depending on the amount of solution to be processed. The autoclave may be sealed after the transfer of the solution to maintain a closed system for the solvothermal synthesis.

The autoclave may be placed in a safe and stable location for the subsequent heating step. The location may be chosen based on the specific requirements of the heating process, such as the temperature, the duration, and the safety considerations. After the transfer of the solution to the autoclave, the synthesis of the cobalt-nickel alloy nanoparticles may proceed as described in the following steps. In some embodiments, the autoclave is never moved from location to location but is kept at the location at which the heating occurs. In some embodiments, the autoclave is attached to a conveyor belt and moved from a location where it is filled to a location where it is heated and cooled and then to a location where the autoclave is emptied. In some embodiments, the heating and cooling occur in different locations.

Following the transfer of the solution to the autoclave, in step 112, the autoclave may be heated to facilitate the solvothermal synthesis of the cobalt-nickel alloy nanoparticles. In some embodiments, the autoclave may be heated and maintained at a temperature of 180° C. This temperature may provide the appropriate conditions for the formation of the nanoparticles, although other temperatures may also be suitable depending on the specific requirements of the synthesis process. The duration of the heating may be set to a specific time period to control the growth of the nanoparticles. In some cases, the autoclave may be heated for 8 hours. The duration of 8 hours, e.g., at 180° C., may allow for the complete formation of the nanoparticles, although other durations may also be suitable depending on the desired size and morphology of the nanoparticles. In some embodiments, the heating of the autoclave may be performed in a controlled environment, such as an oven or a furnace, to maintain a consistent temperature throughout the synthesis. The autoclave may be placed in a safe and stable location within a heating device to ensure uniform heating. Alternatively, a heater may be built into the autoclave.

In step 114, after the heating process, the autoclave may be cooled to ambient temperature. The cooling may be performed gradually to prevent any thermal shock to the synthesized nanoparticles. Once cooled, the autoclave may be opened, and the synthesized cobalt-nickel alloy nanoparticles may be collected for further processing and characterization.

Following the heating process, in step 116, the synthesized cobalt-nickel alloy nanoparticles may be collected from the autoclave. In some embodiments, the collection of the nanoparticles may be performed through centrifugation. The centrifugation process may involve spinning the autoclave at high speeds, which may cause the nanoparticles to separate from the solution and settle at the bottom of the autoclave. The centrifugation may be performed using a centrifuge machine, and the speed and duration of the centrifugation may be adjusted based on the specific requirements of the collection process.

The collected nanoparticles may be washed after the centrifugation of the product having the nanoparticles. The washing of the nanoparticles may involve rinsing the nanoparticles with a suitable solvent, such as distilled water or ethanol, to remove any residual solvents or impurities from the synthesis process. The washing may be performed multiple times to ensure a thorough cleaning of the nanoparticles. Alternatively, the washing step may be skipped for applications in which the end product does not need to be of a high purity and free of solvents.

The washed nanoparticles may be dried for further use. The drying process may involve placing the nanoparticles in a dry environment, such as a vacuum oven or a desiccator, to remove any residual moisture. The temperature and duration of the drying process may be adjusted based on the specific requirements of the drying process. The dried nanoparticles may then be ready for further processing or characterization. The collected, washed, and dried cobalt-nickel alloy nanoparticles may be stored for future use. The storage may involve placing the nanoparticles in a sealed container to prevent exposure to the ambient environment, which may help to maintain the integrity of the nanoparticles. The nanoparticles may be stored at room temperature, although other storage conditions may also be suitable depending on the specific requirements of the storage process. Alternatively, the nanoparticles may be immediately added to the system in which the nanoparticles are deployed (e.g., a fuel cell). The collected cobalt-nickel alloy nanoparticles may be used as a catalyst for ORRs in fuel cells. The nanoparticles may exhibit a catalytic activity towards ORR that is comparable to that of platinum-based catalysts and may exhibit enhanced durability over multiple cycles of ORRs. The use of nanoparticles as a catalyst may provide a cost-effective and efficient alternative to traditional platinum-based catalysts in fuel cells. Alternatively, the nanoparticles may be used in other products, such as for constructing anisotropic conductive materials.

In step 118, the synthesized cobalt-nickel alloy nanoparticles may be characterized and evaluated as an electrode material for ORRs. Step 118 is optional. Once it has been confirmed that the apparatus for synthesizing the nanoparticles functions properly and produces a product having the desired nanowires there is no need to perform step 118 on each batch of product produced by method 100. For example, perhaps only one batch in 100 is evaluated and analyzed to ensure that the apparatus that implements method 100 is still functioning properly. The characterization and evaluation may involve various techniques, such as powder X-ray diffraction (pXRD), x-ray photoelectron spectroscopy (XPS), and electron microscopy, such as SEM and/or TEM. These techniques may provide detailed information about the structure, composition, and morphology of the nanoparticles, which may be useful for understanding their electrocatalytic performance. The pXRD technique may be used to confirm the successful synthesis of the cobalt-nickel alloy nanoparticles. The diffraction peaks obtained from the pXRD analysis may match well with the corresponding reference cards, indicating the formation of the desired alloy structure. The XPS technique may be used to determine the elemental composition of the nanoparticles, confirming the presence of cobalt and nickel in the alloy in the desired amount. The SEM or TEM technique may be used to investigate the morphology of the nanoparticles, revealing the shapes and sizes of the nanoparticles. Each of the characterization techniques (pXRD, XPS, TEM and SEM) is optional. For some applications, another evaluation and analysis technique is performed on only one of the evaluation techniques is performed.

The electrochemical activity of the synthesized cobalt-nickel alloy nanoparticles may be evaluated using a three-electrode setup. This setup may include a Hg/HgO reference electrode, a graphite rod counter electrode, and a RDE working electrode. The synthesized nanoparticles may be dispersed in a mixture of 5% isopropanol and sulfonated tetrafluoroethylene-based fluoropolymer-copolymer, and the resultant slurry may be placed on applied to the RDE. In some embodiments, the placement of the resultant slurry on the electrode is performed by drop-casting. The ORR activity may be measured using a potentiostat or a potentiostat instrument, such as the Gamry potentiostat 5000E connected with an RDE710 rotating electrode instrument.

The electrocatalytic performance of the synthesized cobalt-nickel alloy nanoparticles may be evaluated in an electrolyte solution saturated with oxygen. The electrolyte solution may be 0.1 M KOH, although other electrolyte solutions may also be suitable. In alternative embodiments in which the batch of solution is greater or smaller than 80 ml, the amount of KOH may be proportionally increased or decreased. The linear sweep voltammetry curves recorded during the evaluation may indicate the electrocatalytic activity of the nanoparticles toward ORR. In some embodiments, the synthesized nanoparticles may exhibit a catalytic activity that is comparable to that of platinum-based catalysts and may exhibit enhanced durability over multiple cycles of ORRs.

The nanoparticles may offer a cost-effective and efficient alternative to traditional platinum-based catalysts, and their tunable composition may allow for customization based on specific application requirements. The method for evaluating the electrocatalytic activity of the nanoparticles may provide a reliable and accurate measure of the performance of the nanoparticles in ORRs. The use of these techniques for evaluating the nanoparticles may also provide valuable insights into the synthesis process, potentially leading to further improvements in the synthesis method and the properties of the synthesized nanoparticles. For example, if the ratio of the Ni to Co is not what is desired, the ratio of precursor Co salt to the Ni salt and/or the concentration of KOH may be adjusted. The amount of slurry placed on, or applied to the electrode may be adjusted based on the specific requirements of the electrochemical measurements. For instance, a larger amount of slurry may be applied to achieve a thicker coating of nanoparticles, which may be beneficial for enhancing the electrocatalytic activity of the electrode. Conversely, a smaller amount of slurry may be applied to achieve a thinner coating of nanoparticles, which may be suitable for more sensitive electrochemical measurements. In some embodiments, the coated electrode may be dried after the application of the slurry. This drying process may involve placing the electrode in a dry environment, such as a vacuum oven or a desiccator, to remove any residual solvent from the slurry. The temperature and duration of the drying process may be adjusted based on the specific requirements of the drying process. The dried electrode, coated with the synthesized cobalt-nickel alloy nanoparticles, may then be ready for electrochemical measurements.

The electrocatalytic activity of CoₙNi₁₀₀₋ₙ nanoparticles in O₂ saturated 0.1 M KOH acting as electrolyte and its comparison with benchmark 20 wt % Pt/C showed that the synthesized material has comparable activity with Pt/C towards O₂ reduction. For example, the reaction rate of the Co—Ni alloy nanowire is within 50% of Pt/C. In some embodiments, the reaction rate of the Co—Ni alloy nanowire is within 10% of Pt/C. In some embodiments, the reaction rate of the Co—Ni alloy nanowire is within 5% of Pt/C. In some embodiments, the reaction rate of the Co—Ni alloy nanowire is within 1% of Pt/C. For example, the catalytic activity stays within 10% of an initial catalytic activity and the structure of the nanowire is retained for over 8000 cycles of ORR. Platinum-based catalysts, while effective, are often expensive and subject to degradation over time. The cobalt-nickel alloy nanoparticles, on the other hand, may provide comparable catalytic activity at a lower cost, and may exhibit enhanced durability, compared to platinum-based catalysts. In other words, cobalt-nickel alloy nanoparticles exhibit better durability than the platinum-based catalysts over multiple cycles of ORRs. Consequently, the cobalt-nickel alloy nanoparticles are a good candidate for use as a catalyst in fuel cells. The smaller semicircle demonstrated by EIS studies indicates low charge transfer resistance during the formic acid oxidation on the surface of the electrode. In some embodiments, the cobalt-nickel alloy nanoparticles may be incorporated into the electrode of a fuel cell. The nanoparticles may be dispersed in a suitable binder and applied to the electrode surface, forming a catalytic layer. The nanoparticles may provide a high surface area for the ORR, potentially enhancing the reaction rate and the overall performance of the fuel cell.

Although the specification discusses CoₙNi₁₀₀₋ₙ alloy nanoparticles, alternatively, other CoₙNI_{N-n} alloy nanoparticles can be used. For example, N may be 10, 25, 50, or 200, and n is chosen according to the desired percentage of Co. Also, nanoparticles of other nonprecious metal alloys that lower the energy barrier to the ORR of interest can be used instead of Co and Ni.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further, it is intended that any other embodiments of the present invention that result from any changes in application or method of use or operation, method of manufacture, shape, size, or materials, which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for forming nanoparticles of at least cobalt or nickel, the method comprising:
mixing ethylene glycol and N, N-dimethylformamide to form a first mixture;
dissolving potassium hydroxide in the first mixture, forming a resultant solution;
dissolving, in the resultant solution, a metal salt precursor having at least cobalt or nickel, wherein the dissolving of the metal salt precursor in the resultant solution forms a solution that has the metal precursor salt dissolved therein;
transferring, to an autoclave, the solution having the metal salt precursor dissolved therein; heating the autoclave to form a product having nanoparticles; and
collecting the nanoparticles by centrifuging the product having the nanoparticles.

2. The method for forming nanoparticles of claim 1, wherein the metal salt precursor includes a cobalt salt precursor and a nickel salt precursor, and the nanoparticles are cobalt-nickel alloy nanoparticles.

3. The method for forming nanoparticles of claim 2, the cobalt-nickel alloy nanowire is CoₙNi₁₀₀₋ₙ, where n is greater than 0 and less than 100.

4. The method for forming nanoparticles of claim 2, the nickel salt precursor is nickel II acetylacetonate.

5. The method for forming nanoparticles of claim 2, the cobalt salt precursor is cobalt II acetylacetonate.

6. The method for forming nanoparticles of claim 5, the nickel salt precursor is nickel II acetylacetonate, the method further comprising:
determining a desired composition for the cobalt-nickel alloy nanoparticles; and
setting a molar ratio of cobalt II acetylacetonate and nickel II acetylacetonate, based on the desired composition of the nanoparticles.

7. The method for forming nanoparticles of at least cobalt or nickel of claim 2, the nanoparticles retain a catalytic activity that is within 10% of an initial catalytic activity for over 8000 cycles of oxygen reduction reactions.

8. The method for forming nanoparticles of claim 2, further comprises performing an oxygen reduction reaction in a fuel cell in which the nanoparticles are a catalyst.

9. The method for forming nanoparticles of at least cobalt or nickel of claim 2, the nanoparticles having a diameter ranging from 10 to 100 nanometers.

10. The method for forming nanoparticles of claim 2, the nanoparticles having a length ranging from 1 to 10 microns.

11. The method for forming nanoparticles claim 2, the nanoparticles exhibit a catalytic activity towards oxygen reduction reaction that has a reaction rate that is within 50% of platinum-based catalysts.

12. The method for forming nanoparticles of claim 2, further comprising dispersing the nanoparticles, by adding the nanowire to a mixture of isopropanol and 5% sulfonated tetrafluoroethylene-based fluoropolymer-copolymer mixture in a sonicator with a 100 W power output and about 42 kHz of frequency.

13. The method for forming nanoparticles of claim 1, the dissolving of the metal salt precursor is performed by stirring the metal salt precursor into the resultant solution.

14. The method for forming nanoparticles of at least cobalt or nickel of claim 13, the stirring is performed gently enough to avoid creating turbulence in the solution.

15. The method for forming nanoparticles of claim 13, the stirring is performed gently enough to avoid creating bubbles in the solution.

16. The method for forming nanoparticles of claim 1, the heating of the autoclave including maintaining the autoclave at 180° C. for a period of time sufficient to form CoₙNi₁₀₀₋ₙ.

17. The method for forming nanoparticles of claim 1, the autoclave being lined with polytetrafluoroethylene, the transferring of the solution having the metal precursor salt dissolved therein to the autoclave including transferring 80 mL of the solution having the metal precursor salt dissolved therein to the autoclave and the heating of the autoclave includes maintaining the autoclave at 180° C. for 8 hours.

18. The method for forming nanoparticles of claim 1, the nanoparticles being a CoₙNi₁₀₀₋ₙ alloy, the method further comprising:
filtering the product having the nanoparticles and
drying the product having the nanoparticles, at 70° C. in an oven.

19. The method for forming nanoparticles of claim 1, the method further comprising:
catalytically activating the nanoparticles in an oxidation reduction reaction and extracting energy from the oxidation reduction reaction.

20. A method for forming CoₙNi₁₀₋ₙ alloy nanoparticles comprising:
mixing N, N-dimethylformamide and ethylene glycol to form a mixture of N, N-dimethylformamide and ethylene glycol;
dissolving potassium hydroxide in the mixture of ethylene glycol and N, N-dimethylformamide and ethylene glycol forming a resultant solution;
dissolving a cobalt salt precursor and a nickel salt precursor in the resultant solution to form a solution that has the cobalt salt precursor and the nickel salt precursor dissolved therein, the cobalt salt precursor being cobalt II acetylacetonate and the nickel salt precursor being nickel II acetylacetonate;
transferring to an autoclave the solution that has the cobalt salt precursor and the nickel salt precursor dissolved therein;
heating the solution that has the cobalt salt precursor and the nickel salt precursor dissolved therein to form a product having the ConNi100-n alloy nanoparticles; and
collecting the ConNi100-n alloy nanoparticles by centrifuging the product having the ConNi10-n alloy nanoparticles.
